(19) United States
(12) Patent Application Publication
(10) Pub. No.: US 2009/0032069 A1
(43) Pub. Date: Feb. 5, 2009

(54) NON-AQUEOUS COATING REMOVAL COMPOSITION

(75) Inventors: Neil Wilson, Lake Orion, MI (US); Theodore D. Held, Grosse Pointe Farms, MI (US)

Correspondence Address: HENKEL CORPORATION, 1001 TROUT BROOK CROSSING, ROCKY HILL, CT, 06067, US

(73) Assignee: Henkel AG & Co. KGaA, Duesseldorf (DE)

(21) Appl. No.: 12/185,403

(22) Filed: Aug. 4, 2008

Related U.S. Application Data
(60) Provisional application No. 60/953,520, filed on Aug. 2, 2007.

(51) Int. Cl. C09D 9/00

(52) U.S. Cl. 134/38; 510/212

(57) ABSTRACT

A coating removal composition comprising: A) at least 50% wt of the total composition comprising one or more of non-ionic surfactants and/or anionic surfactants; B) an inorganic base; C) an optional component of one or more multi-functional alcohols, different from A); D) an optional component of one or more tertiary amines; and optionally, E) chelating agents, viscosity modifiers, surfactants different from A)-D), and mixtures thereof; the composition comprising less than 20 wt % water. The coating removal compositions are useful in stripping coatings from substrate surfaces and may be formulated to be essentially free (or, desirably, entirely free) of water and organic solvents classified as volatile organic compounds or HAPS.

This application is a continuation of and claims priority to U.S. Patent Provisional Application No. 60/953,520, filed Aug. 2, 2007.

### FIELD OF THE INVENTION

This invention relates to non-aqueous, liquid compositions used to remove coating, particularly dried and/or cured coatings from metallic and non-metallic substrate surfaces. The liquid coating removal compositions comprise a surfactant component comprising non-ionic surfactants and/or caustic-stable anionic surfactants; an inorganic base; and optionally, at least one multifunctional alcohol and/or an amount of one or more tertiary amines. More particularly, this invention also relates to a process for removal of coating from articles having one or more dried or cured layers of coating; an anhydrous working bath for accomplishing such removal at lower temperatures and/or shorter contact times than conventional coating stripper compositions; and a processes relating thereto.

### BACKGROUND OF THE INVENTION

Applied coatings, such as paint, varnish, lacquer, clearcoat and the like, are designed to remain adhered to substrate surfaces once dried or cured. Such stubborn adherence becomes a problem when removal of the coating from the substrate is desired. Coated metallic and non-metallic articles and components often require re-working, which may include removal of any coating. When the articles to be re-worked require coating removal, it is generally accomplished by grit blasting or chemical stripping means.

Grit blasting, known colloquially as sandblasting, involves propelling hard particles against a coated surface to dislodge bits of coating until the surface appears free of coating. Grit blasting has the drawbacks of leaving particulate residue on the treated surface and surrounding surfaces, incomplete removal of the coating and sometimes results in damage to the substrate surface underlying the coating.

Chemical stripping of articles, particularly those having components or surfaces of aluminum or its alloys, has the drawback of requiring careful control of the stripping bath. The stripping bath must be aggressive enough to remove the coating in a commercially acceptable time frame, without causing damage to the substrate, bath instability, increased sludge production, or uneconomically shortened bath life. Chemical strippers are generally either water-based or organic solvent-based and each has drawbacks.

Current commercial practice in paint removal preponderantly utilizes water-based solutions, that is, compositions that are mostly water, with added amines and/or some organic solvent. To generate a working bath from a water-based composition, components or concentrates are diluted with more water to generate a bath that is at most about 14% solvent and about 85 to 95% water, by weight or volume. The water-based working baths for coating removing according to the prior art are typically more than 50% by weight water. Operating temperature when using a water-based solution is usually what is considered low temperature in the art, from 21° C. to 55° C. (70° F. to 130° F.). A significant drawback of water-based systems is their lack of performance in removing cured coatings from substrates. Attempts to increase the attack of the water-based systems on cured paint by adding caustic typically results in unwanted sludge production as well as corrosion of underlying metal surfaces. This is a particular problem in stripping aluminum surfaces.

A large number of different types of organic solvent-based compositions have been developed for the purpose of removing paint and other organic coatings from substrate surfaces. Organic solvent-based systems also have drawbacks. Many of the stripper formulations currently in commercial use contain substantial quantities of relatively volatile organic solvents classified as “HAPS” (Hazardous Air Pollutants). Although the HAPS solvents may work well removing coatings, they have the drawback of the HAPS designation and accompanying regulation. In view of the recent increase in regulatory restrictions on the use of such substances, the development of coating removal compositions which are substantially or entirely HAPS-free is currently a subject of great interest.

Attempts have been made to formulate low-HAPS and HAPS-free solvent-based strippers with limited success. A drawback of many of the HAPS-free formulations developed to date is that they are not as efficient in removing coating as conventional coating removal compositions, which contain substantial quantities of HAPS-classified solvents. That is, the rate at which a coating is loosened from the substrate surface is often decreased significantly as the volatile organic solvent concentration, i.e. the HAPS ingredients, are reduced. Another drawback of conventional paint strippers having low HAP levels is the requirement for high temperatures (350° F.) for adequate coating removal and poor coating removal performance at lower temperatures, such as those used for water-based systems.

An object of the current invention is to provide a coating removal composition that is substantially or entirely HAPS-free, which also provides adequate rates of coating removal even on completely dried and/or cured coating, and on aged coating, as compared to conventional HAPS-free formulations. Another object of the current invention is to provide a coating removal composition that also provides adequate rates of coating removal at temperatures less than those required by conventional low HAPS strippers for the same treatment time.

Other alternative and/or concurrent objects will become apparent from the description below.

### SUMMARY OF THE INVENTION

The invention is directed to a liquid coating removal composition that comprises one or more surfactants, comprising one or more of non-ionic surfactants and anionic surfactants; and at least one inorganic base; with optional components of multi-functional alcohol and/or tertiary amines, the coating removal composition comprising less than 20 wt % water. The invention is also directed to removal of coating from articles having one or more dried or cured layers of coating; an anhydrous working bath for accomplishing such removal at lower temperatures and/or shorter contact times than conventional coating stripper compositions; and a process of making the anhydrous working bath. Common in the industry are temperatures of between 132° C. and 163° C.; in contrast, in one embodiment of the invention working bath temperatures range between 108° C. to 122° C., and can run at lower temperatures provided that the bath is first heated to greater than 100° C. to remove water as disclosed herein.

It is an object of the invention to provide a process for generating a working coating removal composition that is essentially anhydrous comprising heating the coating removal composition at temperatures greater than 100° C. for a period of time sufficient to evaporate substantially all of the water in the coating removal composition. The level of water in the coating removal composition can be readily determined by dipping an unpainted polished aluminum panel or other article having an aluminum containing surface into the coating removal composition for a time calculated or measured as sufficient to achieve desired paint removal. The panel is then removed and examined for corrosion, which is generally readily ascertainable from visual inspection of a polished aluminum panel due to dulling of the surface. Other testing methods as are known in the art may also be used.

It is an object of the invention to provide a coating removal composition comprising:

A) a surfactant component in an amount of at least 50 wt %, and comprising one or more of non-ionic surfactants and/or anionic surfactants;

B) an inorganic base component in an amount of 0.5-10% wt;

C) a component of one or more non-amine, multi-functional alcohols, different from A);

D) an optional component of one or more tertiary amines; and

E) optionally, chelating agents, viscosity modifiers, surfactants different from A)-D), and mixtures thereof;

the composition containing less than 20% water.

It is a further object of the invention to provide a coating removal composition comprising 5-40 wt % of component D) of one or more tertiary amines.

It is a further object of the invention to provide a coating removal composition wherein component C) is present in an amount of 1-35 wt %.

It is a further object of the invention to provide a coating removal composition wherein component A) is present in an amount of at least 65 wt %.

It is a further object of the invention to provide a coating removal composition wherein the one or more non-ionic surfactants are one or more of alkoxylated aromatic alcohols, nonalkoxylated aromatic alcohols with C₄ or fewer carbons on the aromatic ring, and alkoxylated linear or branched aliphatic alcohols having a C₁ to C₁₀ aliphatic portion. Desirably, the coating removal composition is essentially anhydrous and the one or more non-ionic surfactants comprise alkoxylated linear and/or branched aliphatic alcohols having a C₁ to C₁₀ aliphatic portion. Alternatively, the coating removal composition comprises alkoxylated aromatic alcohols comprising ethoxylated unsubstituted benzyl alcohols, ethoxylated unsubstituted phenols, and mixtures thereof.

It is a further object of the invention to provide a coating removal composition wherein the alkoxylated aromatic alcohol contains at least one aromatic ring and alkoxylate units of General Formula I

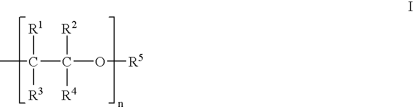

wherein: R¹, R², R³ and R⁴ are independently selected from hydrogen and methyl; R⁵ is hydrogen; and n is 1-10.

It is a further object of the invention to provide a coating removal composition comprising a mixture of alkoxylated aromatic alcohols of General Formula II with a number average Navg. of alkoxylate units from about 1.0-10.0, and wherein R¹, R², R³, R⁴ and R⁵ are as defined for General Formula I, and R⁶, R⁷ and R⁸ are independently selected from hydrogen and C₁-C₄ alkyl

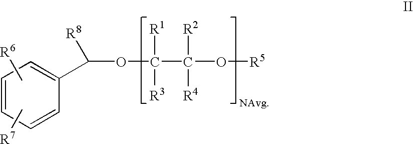

It is a further object of the invention to provide a coating removal composition comprising a mixture of alkoxylated aromatic alcohols of General Formula III with a number average Navg. of alkoxylate units from about 1.0 to about 5, wherein R¹, R², R³, R⁴ and R⁵ are as defined for General Formula I, and R⁶ and R⁷ are independently selected from hydrogen and C₁-C₄ alkyl

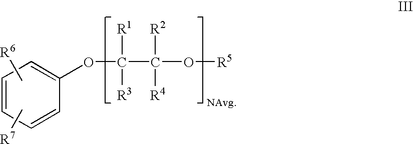

It is also an object of the invention to provide a coating removal composition comprising:

A) a surfactant component, in an amount of at least 50 wt %, comprising one or more of non-ionic surfactants and/or anionic surfactants;

B) an inorganic base component in an amount of 0.5-10% wt;

C) an optional component of one or more multi-functional alcohols, different from A);

D) an optional component of one or more tertiary amines; and

E) optionally, chelating agents, viscosity modifiers, surfactants different from A)-D), and mixtures thereof;

the anhydrous composition containing essentially no water; and

the non-ionic surfactants comprising at least one of:
alkoxylated benzyl alcohols with C₄ or fewer alkyl carbon substituents;
non-alkoxylated aromatic alcohols;
non-aromatic, cyclic alkoxylated alcohols;
linear aliphatic alcohols having aliphatic portions of one to ten carbons and further comprise functionalities selected from ether linkages and ester linkages; and
branched aliphatic alcohols having aliphatic portions of one to ten carbons that further comprise functionalities selected from ether linkages and ester linkages.
It is a further object of the invention to provide a coating removal composition wherein the non-ionic surfactants comprise alkoxylated linear and/or alkoxylated branched aliphatic alcohols.

It is a further object of the invention to provide a coating removal composition wherein the non-ionic surfactants comprise a hydrophobic portion and a hydrophilic portion, the hydrophobic portion comprising ten carbons or less and the hydrophilic portion comprising two to ten moles of alkoxylation.

It is a further object of the invention to provide a coating removal composition wherein the anionic surfactants comprise at least one of phosphonates, sodium cumene sulfonate, sodium xylene sulfonate, and nonenyl succinate anhydride.

It is a further object of the invention to provide a coating removal composition wherein component C) comprises one or more multi-functional alcohols, different from A) that further comprise a tertiary amine functionality, the component C) being present in an amount of 2-44.5% wt.

It is another object of the invention to provide a method of removing a coating from a surface of a substrate, the method comprising;
heating the coating removal composition of claim 1 to a temperature greater than 100° C. for a time sufficient to generate an essentially anhydrous working composition;
contacting a coated surface with the essentially anhydrous working composition for a selected time and temperature effective to loosen and/or remove the coating from the coated surface; and
rinsing with water.

It is a further object of the invention to provide a method wherein the temperature of the anhydrous working composition during the contacting step is from 82° C. to 177° C., the time of contact between the coated surface and the anhydrous working composition is from 1 to 30 minutes and the anhydrous working composition comprises:

A) 50.0 to 99.5% wt of one or more non-ionic surfactants;

B) 0.5 to 5.0% wt. of an inorganic base;

C) optionally, 5 to 40% wt. of a component of one or more multi-functional alcohols, different from A); and

D) optionally, 5.0 to 40% wt. of a component of one or more tertiary amines.

It is a further object of the invention to provide a method wherein the substrate is selected from metallic and non-metallic substrates and rinsing step is followed by an optional second rinsing step comprising rinsing with an acidic rinse.

It is a further object of the invention to provide a method further comprising the step of testing corrosiveness of the coating removal composition by contacting an unpainted article having a surface comprising aluminum with the coating removal composition for a selected testing time period, removing the unpainted article and inspecting for corrosion.

In one embodiment, the one or more of non-ionic surfactants desirably comprise molecules having a hydrophobe portion with less than about 10 carbon atoms and the inorganic base desirably comprises one or more alkali metal hydroxides.

Liquid compositions according to the invention may comprise water or may be essentially free of water. One aspect of the invention comprises an essentially water-free liquid coating removal composition, suitable for use as a working bath. Another aspect of the invention comprises a liquid coating-removal composition containing small amounts of water, for example a packaged product or a fresh working bath prior to initial heating or use.

An object of the current invention is to provide a coating removal composition that is substantially or entirely HAPS-free, which also provides adequate rates of coating removal even on completely dried and/or cured coating, and on aged coating, as compared to conventional HAPS-free formulations.

Yet another aspect of the invention comprises a liquid caustic replenisher for the working bath comprising a high concentration of inorganic base. Component B) may be dissolved in one or more of component A), component C), component D), organic solvent and water. The caustic replenisher may desirably comprise inorganic base in water and/or one or more of organic components A), C) and D) having a boiling point of at least 180° C. (356° F.). The caustic replenisher may desirably include a multi-functional alcohol, such as by way of non-limiting example diethylene glycol.

One aspect is directed to a method of removing coating from the surface of an article comprising heating a working bath of a coating removal composition, as described herein, to 180° F. to 350° F. (82° C. to 177° C.) for a selected amount of time sufficient to eliminate essentially all residual water in the bath.

Articles, for example metal or other materials, such as by way of non-limiting example wood, composite materials and polymeric materials, such as sheet molding compound (SMC) and thermoplastic olefin (TPO), requiring coating removal are then contacted with the coating removal composition. Suitable methods of contacting articles include submerging the articles in a working bath, flowing the coating removal composition over the surface of the article, similar to flow-coating, and spraying the article with the composition for a selected length of time sufficient to remove and/or loosen the coating. The articles are then submerged in a water bath or sprayed with water to remove coating removal composition and residual coating from the article. In another aspect of the process, an optional acidic quench following rinsing may be used to neutralize any alkaline residues.

An object of the invention is to provide coating removal comparable to compositions of the prior art at reduced working bath temperatures for the coating removal composition. Common in the industry are temperatures of between 270° F. (132° C.) to 325° F. (163° C.). The working bath temperatures of the invention may be reduced to 180° F. to 350° F. (82° C. to 177° C.), desirably the temperatures may be between 225° F. (108° C.) and 325° F. (163° C.), desirably between 225° F. (108° C.) and to 275° F. (136° C.).

Another object of the invention is reduced sludging of bath components. This sludging may result from: adverse reaction between the organic portion of the bath and the caustic, from the bath components reaching a saturation level and/or from cooling of a heated solution that has reached supersaturation. Long term exposure of the working bath to ambient atmosphere can also result in capture of CO₂ in the bath as dissolved carbonate and bicarbonate, which can increase sludging by reaction with the caustic.

A related object of the invention is the conservation of caustic in the bath by reduction in the degree of caustic neutralization or precipitation. Caustic in the working bath is typically neutralized by undesirable oxidation/reduction reactions in the bath. Precipitation is often due to changes in bath component concentration and/or reaction products of bath components, which affects the solubility of the caustic.

Further objects of the invention include extended bath life obtained by reduced sludging and caustic neutralization, and reduced treatment time in contact with the coating removal composition to accomplish the stripping at a given temperature.

Except in the claims and the operating examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, throughout this description, unless expressly stated to the contrary: percent, “parts of”, and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ by chemical reactions specified in the description, and does not necessarily preclude other chemical interactions among the constituents of a mixture once mixed; specification of materials in ionic form additionally implies the presence of sufficient counter ions to produce electrical neutrality for the composition as a whole (any counter ions thus implicitly specified should preferably be selected from among other constituents explicitly specified in ionic form, to the extent possible; otherwise such counter ions may be freely selected, except for avoiding counter ions that act adversely to the objects of the invention); the term “paint” includes all like materials that may be designated by more specialized terms such as primer, lacquer, enamel, varnish, shellac, topcoat, and the like; and the term “mole” and its variations may be applied to elemental, ionic, and any other chemical species defined by number and type of atoms present, as well as to compounds with well defined molecules.

### DETAILED DESCRIPTION OF EMBODIMENTS OF THE INVENTION

This invention is directed to a coating removal composition that is particularly suitable for use in removing cured water-borne coating, as well as solvent-borne coating, and the various embodiments described as preferred herein are preferred with respect to such end-use application, but are in no way limiting of the overall breadth of the invention.

Applicants have found that improved coating removal performance and extended bath life in coating removal compositions that are essentially free of water and having low HAPs content can be achieved by using a particular combination of inorganic base and organic components. Applicants also found that an essentially water-free working bath containing strong base and non-ionic surfactants different from nonylphenol surfactants provided coating removal performance at working bath temperatures lower than the prior art.

Compositions according to the invention comprise, desirably consist essentially of, most desirably consist of:

A) at least one surfactant component selected from non-ionic surfactants and anionic surfactants;

B) an inorganic base;

C) an optional component of one or more multi-functional alcohols, different from A); and

D) an optional component of one or more tertiary amines.

Other components known in the art as useful for inclusion in coating removal compositions, such as by way of non-limiting example chelating agents, thickeners, additional surfactants different from A)-D) may be included in the compositions in suitable amounts within the knowledge of one of ordinary skill in the art, provided that they do not adversely affect the performance or stability of the working bath.

Compositions according to the invention are desirably used in the absence of water. The presence of even small amounts of water in the working bath can cause corrosion of some substrates, such as aluminum. Thus, although some water can be present in compositions according to the invention, desirably the amount of water is minimized. Typically, compositions according to the invention comprise less than 20, 10, 5, 4, 3, 2, 1 wt % water.

One embodiment comprises a working bath that is anhydrous or substantially anhydrous. Those of skill in the art will understand that by anhydrous, Applicants mean that not only has no water been affirmatively added to the bath, but also that water has been removed from the bath, by means such as boiling or vacuum treatment, such that water produced in manufacture or included in raw materials has been removed. In a preferred embodiment, water absorbed from the atmosphere is also absent in the working bath at operating temperature.

For component A), suitable non-ionic surfactants are those having a hydrophilic portion, a hydrophobic portion desirably with less than about 10 carbon atoms, and at least one alcohol functional group. Suitable examples include the following:
alkoxylated aromatic alcohols, such as by way of non-limiting example benzyl and phenol alkoxylated alcohols, desirably these alcohols have C₄ or fewer carbon substituents on the aromatic ring;
non-alkoxylated aromatic alcohols, such as by way of non-limiting example 2-phenylethanol and benzyl alcohol may be used provided the composition has a suitably high boiling and flash point, as described herein;
non-aromatic, cyclic alkoxylated alcohols, such as by way of non-limiting example ethoxylated alcohol derivatives of cyclohexane, cycloheptane and the like.
linear or branched aliphatic alcohols of one to ten carbons that further comprise functionalities selected from alkoxylation, other ether linkages and ester linkages, such as by way of non-limiting example, ethylene glycol monohexyl ether and 2,2,4-trimethyl-1,3-pentanediol monoisobutyrate are also suitable as non-ionic surfactants.

Also for component A), suitable anionic surfactants are those which are sufficiently stable in the presence of a concentration of inorganic base of at least 0.5% wt., measured as an amount equivalent to 0.5% wt. KOH, desirably up to about 5 wt % inorganic base or mixtures thereof. Examples of suitable anionic surfactants include phosphonate surfactants, sodium cumene sulfonate, sodium xylene sulfonate, and nonenyl succinic anhydride (salt form after contact with caustic), as well as commercially available anionic surfactants employing nonenyl succinate anhydride and other surfactants such as by way of non-limiting example Triton® DF-20 (commercially available from Dow Chemical), with suitable lack of foaminess

In compositions of the invention, the surfactants act to wet the coating surface, soften the coating and/or participate in the dissolution and removal of the coating. The working bath described herein is desirably non-aqueous and operates at elevated temperatures of 180° F. to 350° F. (82° C. to 177° C.). Components of the working bath described herein as “surfactants” act as both surface active agents, to improve non-aqueous wetting of the coated surface and as organic solvents in the most general sense of dissolving or solvating the coating.

The functioning of the at least one surfactant A) will be understood by those of skill in the art to be somewhat different in the context of a substantially water-free system, as compared to conventional aqueous systems operating at conventional temperatures. In the context of this invention, without being bound by a single theory, Applicants believe that the hydrophobic portion of the surfactant readily interacts with the coating surface and the hydrophilic portion is attracted to the strongly ionic inorganic base, bringing the base into contact with the coating which facilitates the action of the inorganic base. It is also believed that, contrary to conventional thinking and without being bound by a single theory, the inorganic base reacts with the alcoholic hydrogen on the at least one surfactant A) resulting in production of an anion of the surfactant in close association with the cation of the inorganic base and that this anion tends to penetrate and dissolve the coating.

Suitable alkoxylated aromatic alcohols desirably are water-soluble or water-miscible to improve rinseability. For purposes of this invention, alkoxylated alcohol will be understood by those of skill in the art to mean an alcohol that has been reacted with one or more moles of epoxide, such as by way of non-limiting example ethylene oxide, propylene oxide or butylene oxide, resulting in a polyether alcohol. Unless, otherwise specifically described herein, the terminal functional group of the alkoxylate is an alcohol functional group, i.e. —OH.

In one embodiment, component A) is selected from alkoxylated aromatic alcohols containing one or more compounds each containing at least one aromatic ring per molecule and alkoxylate units of General Formula I:

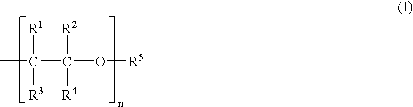

wherein: R¹, R², R³ and R⁴ are independently selected from hydrogen and methyl; R⁵ is hydrogen; and n is 1-10. The value of n is desirably selected to be sufficiently high so as to enable the resulting coating removal composition to be classified as HAPS-free. The alkoxylate units of General Formula I are attached to the aromatic ring directly or through an ether (oxygen) linkage or an oxymethylene (—CHR¹⁸O—) linkage, wherein R⁸ is hydrogen or C₁-C₄ alkyl.

The use of alkoxylated aromatic alcohols permits the formulation of coating removal compositions having a low VOC (Volatile Organic Compound) content. Such alcohols are considerably less volatile than the aliphatic alcohols, glycol ethers, and solvents typically used in such products, but provide compositions that are very effective in removing coating from substrate surfaces. In one embodiment of the present invention, the coating removal composition is essentially free, or, preferably, entirely free, of any organic solvent which is legally regulated as a VOC or HAP.

In one embodiment, the coating removal composition contains one or more compounds each containing at least one aromatic ring and alkoxylate units of General Formula I. The end alkoxylate unit is end-capped (terminated) with a hydrogen atom. The aromatic ring can also contain one or more alkyl substituents of one to four carbons each. Examples of such alkyl substituents include methyl, ethyl, propyl, and isopropyl.

Another embodiment contains one or more alkoxylated aromatic alcohols of General Formula II with a number average (Navg.) of alkoxylate units per molecule from about 1 to about 10, wherein R¹, R², R³, R⁴ and R⁵ are as defined in General Formula I, and R⁶, R⁷ and R⁸ are independently selected from hydrogen and C₁-C₄ alkyl (preferably, no more than one of R⁶-R⁸ is a substituent other than hydrogen). Also, it is preferred that the substituents R¹, R², R³ and R⁴ combine to be at least 60 atom % more preferably at least 80 atom %, hydrogen.

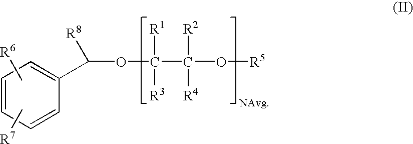

Another embodiment contains one or more alkoxylated compounds of General Formula III with a number average (Navg.) of alkoxylate units from about 1 to about 10, wherein R¹, R², R³, R⁴ and R⁵ are as defined in General Formula I, and R⁶ and R⁷ are independently selected from hydrogen and C₁-C₄ alkyl. Also, it is preferred that the substituents R¹, R², R³ and R⁴ combine to be at least 60%, more preferably at least 80%, hydrogen atoms. Further, it is preferred that R⁶ and R⁷ are both hydrogen atoms.

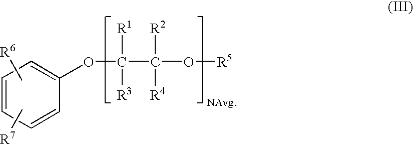

One type of alkoxylated aromatic alcohol that can be used is selected from the Genapol® family of surfactants commercially available Clariant Corporation. For example, Genapol® BA-040 is a mixture of ethoxylated benzyl alcohols that contain from one to about 10 ethoxylate units. A small weight percentage of the alkoxylated aromatic alcohol can be compounds with more than 10 ethoxylate units. The number average (Navg.) of ethoxylate units is about four. Trade names of examples of suitable components include Genapol® BA 020 through Genapol® BA 100.

Another type of alkoxylated aromatic alcohol that can be used is selected from the Harcross® family of products commercially available from Harcross Chemicals, Inc. For example, Harcross® T Det P4 is a mixture of ethoxylated phenols that contain from one to about 10 ethoxylate units, a small weight percentage of the alkoxylated aromatic alcohol can be compounds with more than 10 ethoxylate units. The number average (Navg.) of ethoxylate units is about 3.3. The manufacturer reports that Harcross® T Det P4 includes the following distribution of degrees of ethoxylation where the number of ethoxylate units is indicated by n: 3.3% of n=1; 11.6% of n=2; 19.9% of n=3; 22.4% of n=4; 18.6% of n=5; 12.3% of n=6; 6.7% of n=7; 3.1% of n=8; and 1.26% of n=9.

Another type of alkoxylated aromatic alcohol that can be used is represented by the ST-8329 product commercially available from Clariant. Clariant's ST-8329 is a mixture of ethoxylated benzyl alcohols that contain from one to about 10 ethoxylate units per molecule with a Navg. of ethoxylate units of about four.

It is to be understood that coating removal compositions of the invention are not limited to the three types of commercially available alkoxylated aromatic alcohols noted above. These types are provided only as examples of alkoxylated aromatic alcohols that can be used in the coating removal compositions of the invention. Applicant emphasizes that suitable alkoxylated aromatic alcohols include the general class of compounds defined with an alkoxylate group of General Formula I attached to an aromatic organic moiety. In particular, the aromatic alkoxylated surfactants that can be used in the coating removal compositions of the invention are most preferably of the class of compounds defined by General Formula II or General Formula III.

Specific illustrative types of alkoxylated aromatic alcohols that can be used in the present invention include ethylene glycol monophenyl ether, triethylene glycol monophenyl ether, tetraethylene glycol monophenyl ether, pentaethylene glycol monophenyl ether, hexaethylene glycol monophenyl ether, heptaethylene glycol monophenyl ether, propylene glycol monophenyl ether, triethylene glycol monobenzyl ether, tetraethylene glycol monobenzyl ether, pentaethylene glycol monobenzyl ether, hexaethylene glycol monobenzyl ether, heptaethylene glycol monobenzyl ether, water-soluble ethoxylates of propylene glycol monophenyl ether (preferably, containing an average of at least two oxyethylene moieties per molecule), and the like and mixtures thereof.

Suitable non-aromatic, cyclic alkoxylated alcohols include, by way of non-limiting example, ethoxylated alcohol derivatives of cyclohexane, cycloheptane and the like. Some examples of suitable C₁ to C₁₀ linear or branched aliphatic alcohols comprising alkoxylation or other ether or ester linkages, include ethylene glycol monohexyl ether, 2,2,4-trimethyl-1,3-pentanediol monoisobutyrate, tripropylene glycol butyl ether, tetraethylene glycol butyl ether, and tetrapropylene glycol propyl ether, as well as other C₁ to C₁₀ alcohol alkoxylates meeting the criteria described above. A suitable example is Dowanol™ TPnB commercially available from Dow Chemical Co.

Suitable anionic surfactants include phosphonate surfactants, sodium cumene sulfonate, sodium xylene sulfonate, and nonenyl succinic anhydride (salt form after contact with caustic), as well as commercially available surfactants employing nonenyl succinate anhydride and other surfactants, such as by way of non-limiting example Triton® DF-20 (commercially available from Dow Chemical), with suitable lack of foaminess, meeting the herein described alkali stability requirements.

For component B) one or more inorganic bases are employed in the liquid coating removal composition. Examples of suitable inorganic bases include alkali metal hydroxides, ammonium hydroxide, alkali metal carbonates, alkali metal silicates, alkali metal phosphates, and other basic alkali metal salts, provided that the base does not precipitate in the composition or the working bath and does not cause excessive sludging or reduced bath life. Without being bound by a single theory, the alkali in this non-aqueous coating removal composition is believed to activate the coating surface. Preferred bases are alkali metal hydroxides, such as by way of non-limiting example KOH and NaOH.

The coating removal compositions of the present invention may additionally contain optional component C) one or more multi-functional alcohols, different from A). A multifunctional alcohol will be understood by those of skill in the art to be a molecule having more than one alcohol functional group, i.e. more than one —OH moiety. Initial testing showed that the addition of a multi-functional alcohol to a nonionic surfactant and an alkali metal hydroxide mixture increased the ability of the solution to dissolve higher levels of the alkali metal hydroxide. Without being bound by a single theory, the reaction believed to take place, for instance as KOH dissolves into the non-aqueous solution, is show below.

KOH+R—OH→H₂O↑+R—O⁻K⁺

Accelerated by heating the solution, the hydroxide reacts with the alcoholic hydrogen to form water. The water evaporates out of the bath leaving the potassium salt of the alcohol. This oxide anion is believed to be an active stripping agent. If the reaction is not driven to completion, residual hydrated potassium hydroxide remains in the bath and may aggressively attack light metals such as aluminum. In addition, unreacted caustic in the system may contribute to isolated flakes or particles of caustic clinging to part surfaces, which can cause etch during the rinse stage, an effect known as “snowflaking” in the art. The addition of multi-functional alcohols helps to drive the condensation reaction to completion by making more alcohol groups available to react.

In one embodiment, component C) comprises a non-amine multifunctional alcohol, meaning a molecule having more than one alcohol functional group and no amine functional groups. In an alternative embodiment, component C) may comprise both an amine moiety and multiple —OH groups, such as by way of non-limiting example alkanolamines; desirably the amine moiety is a tertiary amine. In one embodiment, component C) and component D) are the same molecule comprising a tertiary amine moiety as well as multiple —OH groups, such as by way of non-limiting example triethanolamine.

A number of multi-functional alcohols have shown a good ability to aid the dissolving of the alkali metal hydroxides into the coating removal composition. The following is a list of multifunctional alcohols suitable for use in this invention: glycerin, diethylene glycol, tripropylene glycol, tetraethylene glycol, dipropylene glycol, tripropylene glycol, tetrapropylene glycol, neopentyl glycol, trimethylol propane, pentaerythritol and the like. Higher molecular weight multi-functional alcohols may be suitable for use in optional component C) provided that they do not unduly increase stripping time. Higher molecular weight multi-functional alcohols include polyethylene glycols and polypropylene glycols having greater than ten repeating units and alcohol functional polymers such as by way of non-limiting example polyvinyl alcohol.

Optionally, a component of one or more tertiary amines D) may be present in compositions according to the invention. The consumption rate of alkali metal hydroxides exclusive of neutralization by coating residues reduces the stripping performance of the coating removal composition and requires greater alkali metal hydroxide additions to the bath over time. There is a significant advantage to finding ways of inhibiting the consumption rate of hydroxide in the operating bath. Applicants have found that the addition of tertiary amines reduces the loss of alkali from the coating removal composition, while primary and secondary amines do not appear to provide this benefit. Alkanolamines and alkylamines are preferred types of amine. The preferred alkanolamines are selected from triethanolamine, dimethylethanolamine, triisopropanolamine, n-butyldiethanolamine, diethylaminoethanol, or phenyl diethanolamine. Amines which do not contain hydroxyl groups such as by way of non-limiting example alkylamines (e.g., triethylamine) and oxazolidines can also be used.

Additional ingredients may also be present in the coating removal composition such as, for example, chelating agents, thickeners, surfactants, and any of the other additives conventionally used in coating removal formulations, provided that they do not unduly interfere with the objects of the invention.

It is generally preferred that the pH of the coating removal composition be from about 9 to about 14, more preferably from about 10 to about 14. The pH being determined by diluting a 25 ml aliquot of the coating removal composition to 100 ml, total with deionized water and measuring the pH of the aqueous dilution using a standard pH meter in a manner known in the art.

The concentrations of the individual ingredients of the coating removal compositions of the present invention may be varied as may be desired or needed depending upon the type of coating to be removed and the rate at which coating removal is to be effected. Optimal concentrations for a particular application may be readily determined by a worker skilled in the art using standard experimental methods.

In a working coating-removing solution, the concentration of A) the surfactant component as described above desirably is at least 50.0, 55.0, 60.0, 65.0, 70.0, 75.0, 80.0, 85.0, 90.0, 95.0, 96.0, 97.0% by weight and independently preferably is not more than, with increasing preference in the order given, 99.9, 99.5, 99.0, 98.5, 98.0, 97.5, 97.25%

The concentration of B) the inorganic base component in a working bath desirably is at least, with increasing preference in the order given, 0.5, 0.6, 0.7, 0.8, 0.9, 1.0, 1.1, 1.2, 1.3, 1.4, 1.5 1.6, 1.7, 1.8, 1.9. 2.0, 2.1, 2.2, 2.3, 2.4, 2.5, 2.6, 2.7, 2.8, 2.9 or 3.0% and independently preferably, at least for economy, is not more than with increasing preference in the order given, 5, 4.5, 4.2, 4.0, 3.9, 3.8, 3.7, 3.6, 3.5, 3.4, 3.3, or 3.2%.

When present, the concentration of optional component C) one or more multi-functional alcohols, different from A) as described above preferably is at least, with increasing preference in the order given, 1, 2, 3, 4, 5, 10, 15, 20, 21, 22, 23, 24, 25, 26, 27, 28, 29, 30, 31, 32, 33, 34, 35, 36, 37, 38, 39, 40% and independently preferably, at least for economy, is not more than, with increasing preference in the order given, 50.0, 49.0, 48.5, 48.0, 47.5, 47.0, 46.5, 46.0, 45.5, 45.0, 44.5, 44.0, 43.5, 43.0, 42.5, or 42.0%.

If used, the concentration of the tertiary amine D) as described above desirably is at least, with increasing preference in the order given, 6.0, 6.25, 6.5, 6.75, 7.0, 7.25, 7.5, 7.75, 8.0, 8.25, 8.5, 8.75, 9.0 9.5, or 10.0% and independently preferably, at least for economy, is not more than, with increasing preference in the order given, 50.0, 45.0, 40.0, 35.0, 30.0, 25.0, 20.0, 19.0, 18.0, 17.0, 16.0, 15.0, 14.5, 14.0, 13.5, 13.0, 12.5, 12.0, 11.5, 11.0% by weight.

Other conventional agents known in the art for use in coating removal compositions may be included in compositions according to the invention provided that the do no unduly interfere with performance or stability of the compositions. Component E) may comprise chelating agents, additional surfactants and viscosity modifiers, different from A)-D). Examples of viscosity modifiers known in the art include water and organic solvents, including volatile organic solvents, which although not preferred may be used if desired.

Compositions of the invention can be made by combining components A), B) and any optional components, and thereafter removing water from the formulation by heating. It is preferred that as much water as possible is removed from the composition, to lower the etch rate and improve coating removal. In a preferred embodiment, component B) is mixed into component C) and/or D), if used, and thereafter component A) is added to the mixture.

The invention is also directed to a caustic replenisher for the working bath comprising component B), dissolved in one or more of component A), component C), component D), organic solvent and water. The caustic replenisher contains a concentration of inorganic base component B) in the range of 10, 11, 12, 13, 14, 15, 16, 17, 18, 19, 20, 21, 22, 23, 24, 25, 26, 27, 28, 29, 30 wt %. The concentration of inorganic base may be increased, up to the point where the caustic replenisher viscosity is undesirably increased or the replenisher is not sufficiently stable. Desirably, the caustic replenisher is storage stable for at least 1, 2, 3, 4, 5, 6, 7, 8, 9, 10, 11, or 12 months. The caustic replenisher is desirably anhydrous, but may contain small amounts of water up to about in increasing order of preference, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1% wt or less. This caustic replenisher provides a miscible liquid, desirably a substantially water-free, preferably an anhydrous liquid, which allows addition of components to the working bath without introducing excess water. An advantage of the caustic replenisher is that it avoids the difficulty of replenishing inorganic base in the bath with dry flake that resists dissolution in the bath.

In one embodiment, the caustic replenisher may be produced by combining solid inorganic base with multifunctional alcohol and/or anhydrous tertiary amine and heating to remove residual water. One advantage of such a caustic replenisher is that the higher concentration of organic base eliminates use of an aqueous caustic concentrate that requires subsequent removal of water from the bath.

The liquid caustic replenisher can be added continuously to the bath using a metering pump. One advantage of a continuous addition of caustic replenisher in processes according to the invention is that a continuous feed rate more readily maintains a consistent level of inorganic base in the bath. Another advantage is reduced operator involvement with a highly caustic raw material.

The caustic replenisher replaces typical caustics, such as 45% KOH solution in water and solid KOH flake. A 45% KOH solution in water has the drawback of adding significant quantities of water to the working bath which then need to be boiled off, while solid KOH flake has the drawback of incomplete dissolution which creates sludge.

Any of the formulations according to the invention may have a small amount of water as a result of manufacturing processes. Most or all of this water is removed, typically by evaporation, prior to using the working bath or as the working bath is operated at working temperatures. The composition is essentially anhydrous during the coating removal operation. Desirably, any water (and volatile organic solvent, if any, in the replenisher) in the composition is eliminated from the bath by heating of the coating removal composition to a desired working temperature for an amount of time selected such that it is sufficient to evaporate essentially all of the water. Those of skill in the art will recognize that essentially all of the water is rarely 100% of the water in the bath and will generally result in a bath that is essentially anhydrous, meaning that the amount of water present is less than in increasing order of preference 5, 4, 3, 2, 1, 0.5, 0.25, 0.12, 0.1, 0.05, 0.01, 0.005, 0.001 wt %.

Desirably, at least some of the organic ingredients used in compositions according to this invention are selected such that they meet the following criteria: flash point higher than 100° C. (212° F.) in a Tag Closed Cup test, and a boiling point higher than 180° C. (356° F.). In a preferred embodiment, at least 50 wt % of the organic components, most preferably at least 75% of the organic ingredients meet the aforementioned criteria.

The flash point is a consideration relevant to safety of the composition, particularly when heated above ambient temperature. Selecting an appropriate boiling point limits evaporation from the bath, and any foaming that results from this evaporation. Depending on the hydrophobe size, it is desirable that sufficient alkoxylation is present to create a non-ionic surfactant that meets these criteria. In one embodiment, the moles of carbon in the hydrophobe and the moles of alkoxylation are balanced according to the following equation: x+y≦14, where x is the moles of carbon in the hydrophobe and y is the moles of alkoxylation (meaning the moles of ethylene oxide, propylene oxide or butylene oxide) in the molecule. In one embodiment y<10.

The non-aqueous composition may be utilized to remove coating from substrates at temperatures from 180° F. to 350° F. (82° C. to 177° C.). One application particularly suitable for use of the invention is removing coatings from aluminum, but other substrates such as by way of non-limiting example steel, galvanized steel, magnesium, and plastics or composites are also suitable substrates.

A process for removal of coating from a coating covered surface is by contacting the surface with a coating removal composition as described herein. The methods of contacting the surface with the coating removal composition can be accomplished in any number of ways known in the art. Desirably, immersion, flowing-over and spraying methods are used. If the surface to be stripped is readily accessible, then flowing the coating removal composition over the surface of the article, similar to flow-coating, or spraying the article with the composition for a selected length of time sufficient to remove and/or loosen the coating is generally preferred. The mechanical force of the impinging coating removal composition facilitates removal of the coating. On the other hand, if the surface to be stripped has recesses or other shapes that are not readily accessible, immersion will generally be preferred. Of course, both methods can be used in combination and/or varied in ways apparent to those skilled in the art. The optimal component concentrations and temperature of the coating removal composition depend on the method of contact and the type of coating to be removed, among other factors. It is to be understood however, that those skilled in the art can determine optimal conditions for particular coating removal applications by minimal experimentation.

The contact time needed to effect a substantial removal of coating from a surface will depend on the nature and thickness of the coating, the composition of the coating removal composition including the ingredient concentrations, the temperature of the composition, and other factors. With some coatings and under some conditions, contact times of a few minutes (e.g., 2-3 minutes) may be sufficient, while dried or cured coatings may require longer periods of up to 10 minutes or longer, depending on the film build of coating on the surface.

If the coating removal composition is flowed or sprayed onto a surface, the pump pressure will usually range from 1.3 bars to 8.0 bars absolute pressure. The operating temperatures of a working bath according to the invention are between 225° F. (108° C.) and 325° F. (163° C.), desirably between 225° F. (108° C.) and to 275° F. (136° C.). Higher temperatures and pressures generally increase the rate at which the coating is removed from the surface. In one embodiment, the working temperature range is higher.

The invention and its benefits will be better understood with reference to the following examples. These examples are intended to illustrate specific embodiments within the overall scope of the invention as claimed, and are not to be understood as limiting the invention in any way.

### EXAMPLES

The level of caustic potash was maintained at a constant 2.5% wt. level for all examples, unless stated otherwise.

The procedure used for testing stripping performance was as follows: 4″×12″ ACT 6061 aluminum panels commercially available from ACT Corporation, were coated with Alodine® 1500, commercially available from Henkel Corporation, and rinsed with distilled water. The unpolished panels were then painted on one side, using clear powder topcoat from Akzo Nobel, to a cured film thickness of 1.8 to 2.2 mils. The panels were then cut into 4″×2″ coupons.

Compositions for the examples were formulated by combining the components with heating at 270° F. for 30 minutes with continuous stirring. The solutions were cooled to 250° F. prior to stripping testing. Without stirring the solution, coupons were placed into the solutions at an angle with the painted side facing up. The coupons were allowed to dwell in their respective solution for selected amounts of time, as reported below, then were removed and rinsed with water for 4 minutes.

The stripped coupons were visually evaluated by determining the percent of the previously painted surface area that had no residual coating after the stripping process.

### Example 1

Stripping performance of various surfactants mixed with KOH was investigated. The data tabulated in Table 1.0 shows the stripping performance of non-ionic surfactants containing different hydrophobes and varying levels of alkoxylation in the presence of 2.5% wt. KOH.

TABLE 1.0
Non-ionic Surfactant Comparison Study

| | | Carbon | | |
|---|---|---|---|---|
| Formula | | Atoms in | Moles | Visual Stripping |
| ID | Structure | Hydrophobe | of Alkoxylation | Performance* |
| N | C₉-Aromatic C₆-(EO)₉-H | 15 | 9 | 0% |
| O | C₉-Aromatic C₆-(EO)₆-H | 15 | 6 | 0% |
| T | Linear C₁₁ to C₁₅-(EO)₃-H | 11-15 | 3 | 0% |
| S | Linear C₁₀ to C₁₂-(EO)₈-H | 10-12 | 8 | 0% |
| U | Branched C₁₂-(EO)₃-H | 12 | 3 | 10% |
| P | H-(EO)₂-H | 0 | 2 | 20% |
| R | Linear C₄-(PO)₃-H | 4 | 3 | 95% |
| L | Aromatic C₆-(EO)₄-H | 6 | 4 | 100% |

*Visual performance taken after 10 minutes of exposure to the stripping solution heated to 250° F. (122° C.).

The data above indicates that the performance of the non-ionic surfactant drops off significantly when the hydrophobe contains C₁₀ and above carbon atoms. This appears to be independent of the level of alkoxylation. In the absence of a hydrophobe, the performance level also drops significantly, as shown in sample P.

### Example 2

The impact on stripping performance of Formula L from Example 1 when formulated with multifunctional alcohols was evaluated, see results summary in Table 2.0. The formulations comprised 2.5% wt. KOH, 32.5% wt. multifunctional alcohol with the remainder made up by the non-ionic surfactant.

TABLE 2.0
Performance Impact of Alternate Multifunctional Additives

| | | | Visual |
|---|---|---|---|
| Formula | | Multi-functional | Stripping |
| ID | Non-ionic Surfactant | Alcohol | Performance* |
| L | Aromatic C₆-(EO)₄-H | None | 100% |
| K | Aromatic C₆-(EO)₄-H | Tetraethylene | 100% |
| | | Glycol | |
| AJ | Aromatic C₆-(EO)₄-H | Glycerin | 99% |
| W | Aromatic C₆-(EO)₄-H | Diethylane Glycol | 100 |
| Z | Aromatic C₆-(EO)₄-H | Triethanolamine and | 99% |
| | | Triethylene Glycol | |
| V | Aromatic C₆-(EO)₄-H | Triethylene Glycol | 100% |

*Visual performance taken after 10 minutes of exposure to the stripping solution heated to 250 F. (122 C.).

The addition of either a di-functional or tri-functional alcohol did not negatively impact the performance of the stripping solution. For purposes of this example triethanolamine is considered an alcohol.

### Example 3

The performance of compositions according to the invention was evaluated directly against formulations made from the prior art, see Table. 3.0, amounts are in weight percent of the total composition.

TABLE 3.0
Performance Impact of Alternate Multifunctional Additives

| | Non-ionic Surfactant | | | | | *Visual |
|---|---|---|---|---|---|---|
| | Aromatic | Nonylphenol | Triethylene | Triethanol | | Stripping |
| Formula ID | C₆-(EO)₄-H | (EO)₆-H | Glycol | amine | KOH | Performance |
| L | 97.5 | | | | 2.5 | 100% |
| Comparative A¹ | | 10 | 87.5 | | 2.5 | 10% |
| Comparative B² | | 10 | 70 | 17.5 | 2.5 | 10% |

¹Based on U.S. Pat. No. 7,151,080
²Based on US Patent Application No. 2003/0144164
*Visual performance was taken after 10 minutes of exposure to the stripping solution heated to 250° F. (122° C.).

### Example 4

The performance of non-ionic surfactant formulations containing 65% wt. aromatic C₆-(EO)₄—H alcohol, 2.5% wt. KOH and 32.5% wt. of varying multi-functional alcohols was evaluated, see Table 4.0.

TABLE 4.0
Performance Impact of Ethylene Glycols at 10 min. Strip Time

| For- | | | Time in | Visual |
|---|---|---|---|---|
| mula | Non-ionic | | Bath | Stripping |
| ID | Surfactant | Glycol | (min.) | Performance* |
| W | Aromatic C₆-(EO)₄-H | Diethylene | 10 | 100% |
| | | Glycol | | |
| V | Aromatic C₆-(EO)₄-H | Triethylene | 10 | 100% |
| | | Glycol | | |
| K | Aromatic C₆-(EO)₄-H | Tetraethylene | 10 | 100% |
| | | Glycol | | |

*Visual performance taken after 10 minutes of exposure to the stripping solution heated to 250 F. (122 C.).

The above results show equal performance for the three ethylene glycol samples at 10 minutes of bath exposure.

The same evaluation at 5 minutes of bath exposure showed some potential performance differences, as listed in Table 5.0.

TABLE 5.0
Performance Impact of Ethylene Glycols at 5 min. Strip Time

| | | | Time in | Visual |
|---|---|---|---|---|
| Formula | Non-ionic | | Bath | Stripping |
| ID | Surfactant | Glycol Added | (min.) | Performance* |
| W | Aromatic | Diethylene Glycol | 5 | 50% |
| | C₆-(EO)₄-H | | | |
| V | Aromatic | Triethylene Glycol | 5 | 20% |
| | C₆-(EO)₄-H | | | |
| K | Aromatic | Tetraethylene | 5 | 80% |
| | C₆-(EO)₄-H | Glycol | | |

*Visual performance taken after 5 minutes of exposure to the stripping solution heated to 250 F. (122 C.).

### Example 5

The performance impact of varying levels of KOH was evaluated in a system based upon Formula V, containing a constant 65% wt of aromatic C₆-(EO)₄—H alcohol and a selected amount of KOH with the remainder of the composition being triethylene glycol. The performance summary is listed in Table 6.0 & 7.0.

TABLE 6.0
Performance Impact of KOH level at 10 min. Strip Time

| Formula | Non-ionic | | Time in | Visual Stripping |
|---|---|---|---|---|
| ID | Surfactant | KOH % wt. | Bath | Performance* |
| Y | Aromatic | 0% wt. | 10 minutes | 0% |
| | C₆-(EO)₄-H | | | |
| X | Aromatic | 1.0% wt. | 8 minutes | 100% |
| | C₆-(EO)₄-H | | | |
| V | Aromatic | 2.5% wt. | 8 minutes | 100% |
| | C₆-(EO)₄-H | | | |

*Visual performance taken after 8 or 10 minutes of exposure to the stripping solution heated to 250 F. (122 C.).

Provided that there is KOH present, the data shows similar stripping efficiency independent of the KOH level for the panels evaluated. Greater performance differences are seen if the coating film thickness on the test coupon was increased or the time of exposure was reduced, see Table 7.0.

TABLE 7.0
Performance Impact of KOH level at 5 min. Strip Time

| | Non-ionic | KOH | Time in | Visual Stripping |
|---|---|---|---|---|
| Formula ID | Surfactant | % wt. | Bath | Performance* |
| X | Aromatic | 1.0% wt. | 5 minutes | 90% |
| | C₆-(EO)₄-H | | | |
| V | Aromatic | 2.5% wt. | 5 minutes | 90% |
| | C₆-(EO)₄-H | | | |
| AI | Aromatic | 5.0% wt. | 5 minutes | 95% |
| | C₆-(EO)₄-H | | | |

*Visual performance taken after 5 minutes of exposure to the stripping solution heated to 250 F. (122 C.).

### Example 6

The degree of apparent KOH neutralization in coating removal formulations under short term use conditions was investigated by preparing coating removal formulations and heating them to working bath temperatures for selected periods of time. Simple CO2 absorption from the atmosphere, possibly a factor in long term use of a bath, was disregarded for purposes of this experiment. During the course of this experiment, no quantity of gaseous CO2 was seen when acidifying coating removal baths where the titration had dropped.

Procedure for this experiment: Representative stripper components were mixed with KOH, as describe below. The mixtures were held at selected temperatures for two days and one week, and the decay of the titration of KOH was monitored. In addition, the effect of an addition of triethanolamine (TEA), which is both a multifunctional alcohol and a tertiary amine was examined. The following samples were made:

TABLE 8.0
Samples for testing KOH neutralization (wt %)

| | Sample No. | | | | | | | | | |
|---|---|---|---|---|---|---|---|---|---|---|
| | A | B | C | D | E | F | G | H | I | J |
| Diethylene glycol | 95 | — | — | — | — | — | 85 | — | — | — |
| Triethylene glycol | — | 95 | — | — | — | — | — | 85 | — | — |
| Tetraethylene glycol | — | — | 95 | — | — | — | — | — | 85 | — |
| Aromatic C₆-(EO)₄-H | — | — | — | 95 | — | — | — | — | — | 85 |
| Triethanolamine | — | — | — | — | 95 | — | 10 | 10 | 10 | 10 |
| C₉H₁₉—C₆H₄-(EO)₆-H | — | — | — | — | — | 95 | — | — | — | — |
| KOH flake | 5 | 5 | 5 | 5 | 5 | 5 | 5 | 5 | 5 | 5 |

Each sample was heated to 300° F. and then placed on a 250° F. hotplate for approximately 10 minutes to dissolve the KOH and drive off any incipient water from the condensation reaction. The samples were then passively cooled to room temperature and an initial titration was performed for each one. After determining the initial titration value, the samples were placed in a 250° F. oven for the exposure times of interest, see Table 9.0. The titration procedure consisted of weighing 10.0 grams of the sample into a 100 ml beaker. 50 ml of deionized water was added (80 ml in the case of sample E, which was very thick and resistant to viscosity reduction with water) and the mixture stirred with a stir bar until uniform. Titration was then performed with a pH meter and Titrating Solution 60 (1N H₂SO₄) to a pH of 8.2, with constant stirring.

The results of adding an optional tertiary amine to a coating removal formulation according to the invention were evaluated. It was observed that the caustic level in coating removal formulations dropped over time when continuously heating the various coating removal formulations above 200° F. (94° C.). It was also observed that coating removal samples containing triethanolamine did not darken as much after heating the samples to a temperature of 250° F. (122° C.) for at least 2 hours.

Evidence of instability, believed to be linked to undesirable alkali attack, was seen in darkening of the sample, precipitation and skin formation. It appears that both the aromatic alkoxylate (D, J) and the nonylphenol alkoxylate (F) had stability issues under the test conditions.

TABLE 9.0
Initial and Aged Bath KOH Titration Results

| | | Titration | | |
|---|---|---|---|---|
| | Initial | After | | |
| | Titration | 42 Hrs. | Percent | |
| Sample | (ml) | (ml) | Loss | Observations After 42 Hrs. |
| A | 7.1 | 6.5 | 8.5% | Dark, skin and precipitate free |
| B | 7.1 | 5.5 | 22.5% | Dark, skin and precipitate free |
| C | 6.7 | 5.2 | 22.4% | Dark, skin and precipitate free |
| D | 6.7 | 4.2 | 37.3% | Skin + bottom sludge |
| | | (mother | | |
| | | liquor) | | |
| E | 27.4 | 29.0 | N/A | Semi-skinned, gel-like layer |
| | | (mother | | |
| | | liquor) | | |
| F | 6.3 | 3.7 | 41.3% | Skin + bottom sludge |
| | | (mother | | |
| | | liquor) | | |
| G | 9.1 | 8.9 | 2.2% | Light tan, skin and ppt.-free |
| H | 9.4 | 8.4 | 11.9% | Dark tan, skin and ppt.-free |
| I | 8.7 | 7.8 | 10.3% | Dark brown, skin and |
| | | | | ppt.-free |
| J | 9.0 | 7.3 | 18.9% | Skin + bottom sludge |
| | | (mother | | |
| | | liquor) | | |

Titrations of the unstable mixtures after heat exposure were performed on samples taken from the undisturbed mother liquor as indicate in the table. Sample E appears to have lost no alkalinity at all, with the titration increase likely being due to experimental error.

Comparing samples, with and without added triethanolamine, shows that addition of triethanolamine appeared to inhibit darkening. The color differences were noticeable with a color trend based: di<tri<tetra for the glycol. The loss of titration points after 42 hours was also diminished, see Table 10.0.

TABLE 10.0
Change in Titration Results in Sample Baths with and without TEA

| Solution Pair | OH-substituted Organic Molecule | Loss Inhibition |
|---|---|---|
| A and G | Diethylene Glycol | 74% |
| B and H | Triethylene Glycol | 47% |
| C and I | Tetraethylene Glycol | 54% |
| D and J | Aromatic C₆-(EO)₄-H | 49% |

The study demonstrated that triethanolamine in the coating removal formulation at 10% wt inhibits the loss of caustic over time when the coating removal formulations were heated to 250° F. (122° C.) for 42 hours.

### Example 7

The combined impact of a multi-functional alcohol and a tertiary amine on performance of coating removal formulations was tested. The amounts of Aromatic C₆-(EO)₄—H and triethylene glycol were keep relatively constant, while the level of KOH and triethanolamine (TEA) were varied, see Table 11.0.

TABLE 11.0
Performance Impact of varying KOH amounts

| | | | | | Visual |
|---|---|---|---|---|---|
| Formula | Non-ionic | | | Time in | Stripping |
| ID | Surfactant | KOH | TEA | Bath | Performance* |
| AA | Aromatic | 0% wt. | 12.5% wt. | 10 | 0% |
| | C₆-(EO)₄-H | | | minutes | |
| AB | Aromatic | 1.0% wt. | 12.5% wt. | 10 | 90% |
| | C₆-(EO)₄-H | | | minutes | |
| Z | Aromatic | 2.5% wt. | 10.0% wt. | 10 | 99% |
| | C₆-(EO)₄-H | | | minutes | |

*Visual performance taken after 10 minutes of exposure to the stripping solution heated to 250 F. (122 C.).

The results indicate that without KOH the stripping bath does not remove the coating. With the addition of KOH to the formulation, the stripping performance increased significantly.

The foregoing examples have been provided as illustrative of the invention and are not intended to limit the scope of the invention. Those of skill in the art will recognize that many other surfactants may be as suitable or more suitable given the goals of sludge reduction and caustic neutralization.

This invention relates to a coating removal compositions and processes for removing coatings utilizing this product. It can be used in many variations of the processes that are employed industrially. While the invention has been described in terms of specific embodiments thereof it will be appreciated that other forms could readily be adapted by one skilled in the art. Accordingly, the scope of the invention is to be considered limited only by the following claims.

What is claimed is:

1. A coating removal composition comprising:
A) a surfactant component in an amount of at least 50 wt %, and comprising one or more of non-ionic surfactants and/or anionic surfactants;
B) an inorganic base component in an amount of 0.5-10% wt;
C) a component of one or more non-amine, multi-functional alcohols, different from A);
D) an optional component of one or more tertiary amines; and
E) optionally, chelating agents, viscosity modifiers, surfactants different from A)-D), and mixtures thereof;
the composition containing less than 20% water.

2. The coating removal composition of claim 1 comprising 5-40 wt % of component D) of one or more tertiary amines.

3. The coating removal composition of claim 1 wherein component C) is present in an amount of 1-35 wt %.

4. The coating removal composition of claim 1 wherein component A) is present in an amount of at least 65 wt %.

5. The coating removal composition of claim 1 wherein the one or more non-ionic surfactants are one or more of alkoxylated aromatic alcohols, nonalkoxylated aromatic alcohols with C₄ or fewer carbons on the aromatic ring, and alkoxylated linear or branched aliphatic alcohols having a C₁ to C₁₀ aliphatic portion.

6. The coating removal composition of claim 5 wherein the composition is essentially anhydrous and the one or more non-ionic surfactants comprises alkoxylated linear and/or branched aliphatic alcohols having a C₁ to C₁₀ aliphatic portion.

7. The coating removal composition of claim 5 wherein the alkoxylated aromatic alcohols comprise ethoxylated unsubstituted benzyl alcohols, ethoxylated unsubstituted phenols, and mixtures thereof.

8. The coating removal composition of claim 5 wherein the alkoxylated aromatic alcohol contains at least one aromatic ring and alkoxylate units of General Formula I 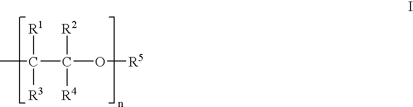
wherein: R¹, R², R³ and R⁴ are independently selected from hydrogen and methyl; R⁵ is hydrogen; and n is 1-10.

9. The coating removal composition of claim 5 comprising a mixture of alkoxylated aromatic alcohols of General Formula II with a number average Navg. of alkoxylate units from about 1.0-10.0, and wherein R¹, R², R³, R⁴ and R⁵ are as defined for General Formula I, and R⁶, R⁷ and R⁸ are independently selected from hydrogen and C₁-C₄ alkyl

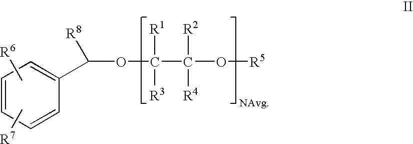

10. The coating removal composition of claim 5 comprising a mixture of alkoxylated aromatic alcohols of General Formula III with a number average Navg. of alkoxylate units from about 1.0 to about 5, wherein R¹, R², R³, R⁴ and R⁵ are as defined for General Formula I, and R⁶ and R⁷ are independently selected from hydrogen and C₁-C₄ alkyl

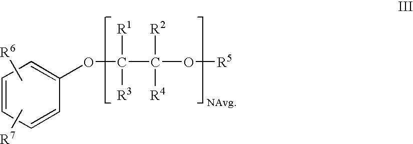

11. An anhydrous coating removal composition comprising:
A) a surfactant component, in an amount of at least 50 wt %, comprising one or more of non-ionic surfactants and/or anionic surfactants;
B) an inorganic base component in an amount of 0.5-10% wt;
C) an optional component of one or more multi-functional alcohols, different from A);
D) an optional component of one or more tertiary amines; and
E) optionally, chelating agents, viscosity modifiers, surfactants different from A)-D), and mixtures thereof;
the anhydrous composition containing essentially no water; and
the non-ionic surfactants comprising at least one of:
alkoxylated benzyl alcohols with C₄ or fewer alkyl carbon substituents;
non-alkoxylated aromatic alcohols,
non-aromatic, cyclic alkoxylated alcohols;
linear aliphatic alcohols having aliphatic portions of one to ten carbons and further comprise functionalities selected from ether linkages and ester linkages; and
branched aliphatic alcohols having aliphatic portions of one to ten carbons that further comprise functionalities selected from ether linkages and ester linkages.

12. The coating removal composition of claim 11 wherein the non-ionic surfactants comprise alkoxylated linear and/or alkoxylated branched aliphatic alcohols.

13. The coating removal composition of claim 11 wherein the non-ionic surfactants comprise a hydrophobic portion and a hydrophilic portion, the hydrophobic portion comprising ten carbons or less and the hydrophilic portion comprising two to ten moles of alkoxylation.

14. The coating removal composition of claim 11 wherein the anionic surfactants comprise at least one of phosphonates, sodium cumene sulfonate, sodium xylene sulfonate, and nonenyl succinate anhydride.

15. The coating removal composition of claim 11 wherein component A) is present in an amount of at least 65 wt %.

16. The coating removal composition of claim 11 wherein component C) is a non-amine multifunctional alcohol present in an amount of 1-35 wt %.

17. The coating removal composition of claim 11 wherein component C) comprises one or more multi-functional alcohols, different from A) that further comprise a tertiary amine functionality, the component C) being present in an amount of 2-44.5% wt.

18. A method of removing a coating from a surface of a substrate, the method comprising:
heating the coating removal composition of claim 1 to a temperature greater than 100° C. for a time sufficient to generate an essentially anhydrous working composition;
contacting a coated surface with the essentially anhydrous working composition for a selected time and temperature effective to loosen and/or remove the coating from the coated surface; and
rinsing with water.

19. The method of claim 18 wherein the temperature of the anhydrous working composition during the contacting step is from 82° C. to 177° C., the time of contact between the coated surface and the anhydrous working composition is from 1 to 30 minutes and the anhydrous working composition comprises:
A) 50.0 to 99.5% wt of one or more non-ionic surfactants;
B) 0.5 to 5.0% wt. of an inorganic base;
C) optionally, 5 to 40% wt. of a component of one or more multi-functional alcohols, different from A); and
D) optionally, 5.0 to 40% wt. of a component of one or more tertiary amines.

20. The method of claim 18 wherein the substrate is selected from metallic and non-metallic substrates and rinsing step is followed by an optional second rinsing step comprising rinsing with an acidic rinse.

21. The method of claim 18 further comprising the step of testing corrosiveness of the coating removal composition by contacting an unpainted article having a surface comprising aluminum with the coating removal composition for a selected testing time period, removing the unpainted article and inspecting for corrosion.
